(19) United States
(12) Patent Application Publication
(10) Pub. No.: US 2002/0043752 A1
(43) Pub. Date: Apr. 18, 2002

(54) Bench vice

(75) Inventors: Philip Reed, Sheffield (GB); John David Cross, Coventry (GB); Michael Cameron Bainton, Kineton (GB); Paul Howell, Pontefract (GB)

Correspondence Address: BRINKS HOFER GILSON & LIONE, P.O. Box 10395, Chicago, IL, 60610, US

(73) Assignee: Record Tools Limited

(21) Appl. No.: 09/924,924

(22) Filed: Aug. 8, 2001

(30) Foreign Application Priority Data
Oct. 13, 2000 (GB) 0025135.5

(51) Int. Cl. B25B 1/02

(52) U.S. Cl. 269/166

(57) ABSTRACT

A bench vice comprises a fixed jaw and a moveable jaw, both sliding on a slide bar. The jaws are made of plastics material and are supported against pressures imposed by the slide by pins retained in the jaws. One of the pins on the fixed jaw is knurled to provide a jamming function against the slide. The moveable jaw has a knob screwed onto a block fixed on the slide, so that rotation of the knob advances the moveable jaw along the slide, or releases it.

Structural rigidity is provided by a convoluted wall and supporting gussets. A pocket is provided for storage of accessories or the like.

### TECHNICAL FIELD

This application relates to bench vices suitable for mounting on a tabletop, workbench, Workmate (TM) or the like.

### BACKGROUND OF THE INVENTION

A problem with known types of vice is that the numerous component parts thereof mean that the clamp is relatively expensive to manufacture. Furthermore, if the clamp is of relatively complex construction it may be similarly complex to operate. In particular, it is inconvenient to have to use both hands in order to clamp an object in the clamp and a one-handed operation would be more desirable. Also, vices tend to be heavy and are normally fixed to a work surface.

It is therefore an object of the present invention to provide a clamp which alleviates the above-described problems.

### SUMMARY OF THE INVENTION

According to a first aspect of the invention there is provided a bench vice comprising:

a fixed jaw having a first face;

a moveable jaw having a second face adapted to face the first face;

a bar connecting the jaws, along which bar the jaws are slidable towards and away from one another, the bar being arranged transversely of said faces and being laterally spaced therefrom;

a jamming mechanism between the fixed jaw and bar to selectively prevent sliding of the fixed jaw with respect to the bar; and,

a cam knob on the bar acting on the moveable jaw and adapted, on actuation by a user, to urge the moveable jaw along the bar towards the fixed jaw.

The term “cam knob” is not be understood as limited to a lobed cam but does include other camming arrangements such as screw threads.

Preferably, said jamming mechanism comprises pins disposed in the fixed jaw above and below the bar and arranged to bear against the bar and resist rotational movement of the fixed jaw about a transverse axis through the bar caused by direct or indirect contact between the first and second faces, at least one pin on the fixed jaw being knurled so as to jam against the bar and prevent its sliding in the fixed jaw when pressure on the first face tends to create said rotational movement.

The cam knob may be so arranged that a user can grasp the knob with one hand and use the knob both as a handle with which to slide the movable jaw back and forth along the bar with respect to the fixed jaw, so that an object can be adjustably positioned between the jaw faces and, on actuation of the knob, to clamp finally the object between the faces.

According to a second aspect of the invention there is provided a bench vice comprising:

a fixed jaw made substantially of plastics material and having a first face;

a moveable jaw, also made substantially of plastics material and having a second face adapted to face the first face;

a bar connecting the jaws, along which bar the jaws are slidable towards and away from one another, the bar being arranged transversely of said faces and being laterally spaced therefrom;

guide means disposed in each jaw above and below the bar and arranged to bear against the bar and resist rotational movement of the jaws about transverse axes through the bar caused by direct or indirect contact between the first and second faces, the guide means on the fixed jaw being able to jam against the bar and prevent its sliding in the fixed jaw when pressure on the first face tends to create said rotational movement; and,

a cam knob on the bar acting on the moveable jaw and adapted, on actuation by a user, to urge the moveable jaw along the bar towards the fixed jaw; whereby,

a user can grasp the knob with one hand and use the knob both as a handle with which to slide the movable jaw back and forth along the bar with respect to the fixed jaw, so that an object can be adjustably positioned between the jaw faces and, on actuation of the knob, to clamp finally the object between the faces.

According to a third aspect of the invention there is provided a bench vice comprising:

a fixed jaw comprising an injection moulding of plastics material and having a first face;

a moveable jaw, also comprising an injection moulding of plastics material and having a second face adapted to face the first face;

a bar connecting the jaws, along which bar the jaws are slidable towards and away from one another, the bar being arranged transversely of said faces and being laterally spaced therefrom; and,

guide means disposed in each jaw above and below the bar and arranged to bear against the bar and resist rotational movement of the jaws about transverse axes through the bar caused by direct or indirect contact between the first and second faces, the guide means on the fixed jaw being able to jam against the bar and prevent its sliding in the fixed jaw when pressure on the first face tends to create said rotational movement; wherein,

the fixed jaw comprises a wall extending both from the top to bottom of the fixed jaw and from side to side of the fixed jaw; the wall forming:

said first face in a first plane at the top of the fixed jaw;

a bracing surface substantially perpendicular to said first plane intermediate said top and bottom of the jaw, first gussets extending between said first face and bracing surface in order to support the first face;

a substantially cylindrical support wall, having an axis extending transversely to said bracing surface, between them the support wall and first face substantially defining the extent of said bracing wall; and,

a floor forming a base of the fixed jaw arranged substantially perpendicular to said first plane and having second gussets extending between said floor, support wall and bracing wall.

According to a fourth aspect of the invention there is provided a bench vice comprising:

a fixed jaw comprising an injection moulding of plastics material and having a first face;

a moveable jaw, also comprising an injection moulding of plastics material and having a second face adapted to face the first face;

a bar connecting the jaws, along which bar the jaws are slidable towards and away from one another, the bar being arranged transversely of said faces and being laterally spaced therefrom; and,

guide means disposed in each jaw above and below the bar and arranged to bear against the bar and resist rotational movement of the jaws about transverse axes through the bar caused by direct or indirect contact between the first and second faces, the guide means on the fixed jaw being able so as to jam against the bar and prevent its sliding in the fixed jaw when pressure on the first face tends to create said rotational movement; wherein,

the fixed jaw comprises a pocket forming a store, which pocket is on the jaw on a side of said first face remote from the second face.

Here, the faces are preferably formed from discrete elastomeric material inserts attached to the jaws, and in which the insert on the face of the fixed jaw has a hinged extension forming a cover for said pocket.

In any of the aforementioned aspects, there are preferably two of said bars disposed parallel and spaced from one another.

According to a fifth aspect of the invention there is provided a bench vice comprising:

a fixed jaw comprising an injection moulding of plastics material and having a first face;

a moveable jaw, also comprising an injection moulding of plastics material and having a second face adapted to face the first face;

a bar connecting the jaws, along which bar the jaws are slidable towards and away from one another, the bar being arranged transversely of said faces and being laterally spaced therefrom; and

guide means disposed in each jaw above and below the bar and arranged to bear against the bar and resist rotational movement of the jaws about transverse axes through the bar caused by direct or indirect contact between the first and second faces, the guide means on the fixed jaw being able so as to jam against the bar and prevent its sliding in the fixed jaw when pressure on the first face tends to create said rotational movement; wherein,

no more than one bar is provided, a stabilising rod being integrally formed on the movable jaw parallel the bar and extending through a slot in the fixed jaw to stabilise the movable jaw and reduce any tendency of the movable jaw to rotate relative to the fixed jaw about an axis along the bar.

In this aspect, the rod is preferably L-shaped in section. Moreover, two stabilising rods may be provided, one on either side of the bar.

In any of the above described aspects of the invention the guide means on the fixed jaw preferably comprises pins disposed above and below the bar and, ideally, at least one pin is knurled so as to jam against the bar.

The cam knob, when it is provided, is preferably screw threaded on a stud member formed on the end of the bar and has an end bearing surface which is adapted to engage a front surface of the moveable vice jaw.

The bar is preferably an elongate rectangle in section. Moreover, when pins are employed, the bars may be elongate in section in the direction of a line joining said pins.

When employed, said pins are preferably offset with respect to one another in the direction of said bar, the pin in each jaw nearest the bar being disposed on the same side of the bar as the jaw faces.

In the third aspect of the invention said pins in the fixed jaw preferably extend through at least two of said second gussets, at least one on either side of the bar.

The fixed jaw preferably comprises a base selectively detachable from the fixed jaw and which includes means for secure fixation to a bench or like surface. The fixation means may comprise a screw clamp having a screw adapted to clamp on an edge of a bench, or screw holes to receive screws with which to fix the base to the bench or like surface.

One of the base or fixed jaw preferably has opposing wings adapted to slide in facing channels formed in the other of the base or fixed jaw, whereby the fixed jaw can slide into engagement with the base, retention means being provided to selectively prevent disengagement of one from the other. Indeed, it is preferred that not only does the retention means retain the fixed jaw on the base, but also that it wedges the two together so that there is no slack play between them.

Said retention means therefore may comprise a cam lever pivotally disposed in one of the base and fixed jaw and provided with a cam surface which, on pivoting of said cam lever, both locks the base to the fixed jaw and wedges between them to take up slack play between them. Said cam surface may be in two parts, a first circumferential part forming a spiral centred on the axis of said pivot, and a second radial ramp surrounding said pivot, each part adapted to press corresponding surfaces of the fixed jaw and/or base on actuation of the lever to press the fixed jaw and base with respect to one another in orthogonal directions.

### BRIEF DESCRIPTION OF THE DRAWINGS

Preferred embodiments of the invention are now more particularly described, by way of example only, with reference to the accompanying drawings in which:

FIG. 1 is a side view of a vice embodying the invention;

FIG. 2 is a section on line A-A in FIG. 1;

FIG. 3 is a top view of the vice of FIG. 1;

FIG. 4 is a section on line B-B in FIG. 3;

FIG. 5 is a side view of the FIG. 1 vice with its back cover open and base removed;

FIG. 6 is side view of a second embodiment of the vice of the present invention, shown with its jaws open;

FIG. 7 is a top view of the FIG. 6 vice;

FIG. 8 is a bottom view of the FIG. 6 vice;

FIG. 9 is a section on line H-H in FIG. 7, with the jaws of the vice shown closed;

FIG. 10 is a section on line I-I in FIG. 9;

FIG. 11 is one end view of the vice of the FIG. 6, from the direction of the moveable jaw;

FIG. 12 is the other end view of the vice of FIG. 11;

FIG. 13 is a top perspective dismantled view of the fixed jaw, cam lever and base of a vice as shown in FIG. 6;

FIG. 14 is a corresponding under view; and

FIG. 15 is a more detailed side-sectional view of the fixed jaw as shown in FIG. 9.

### DESCRIPTION OF THE PREFERED EMBODIMENTS

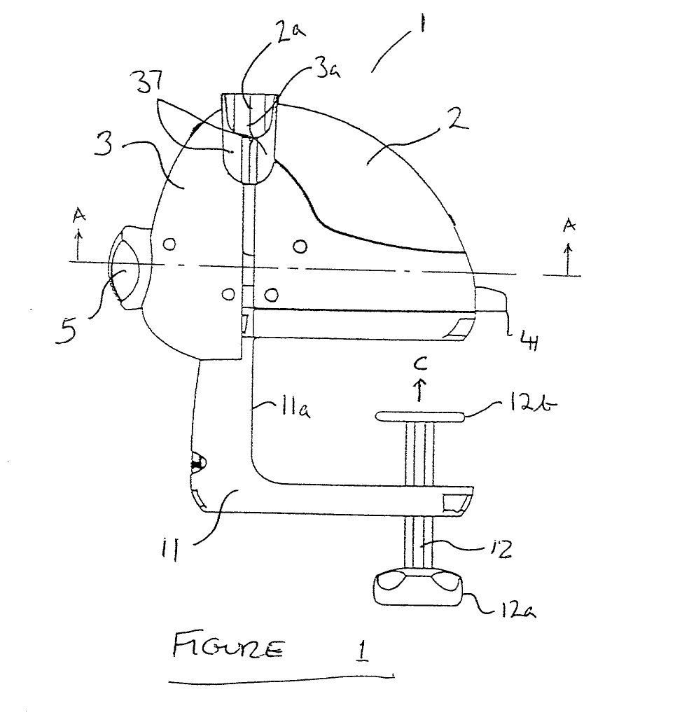

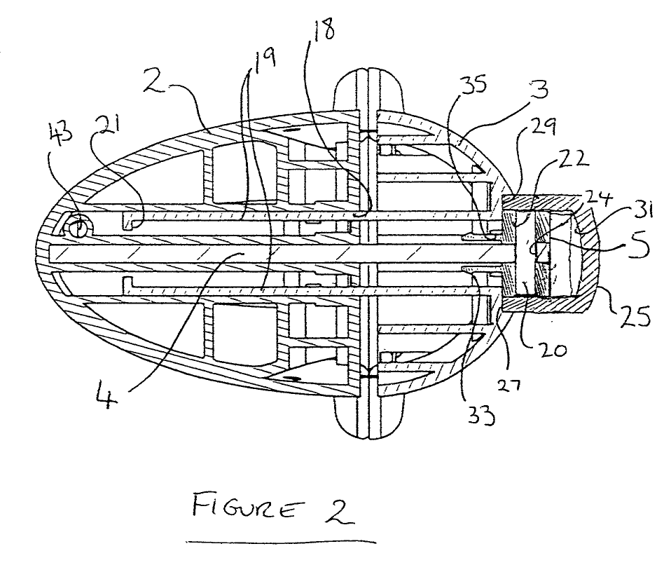

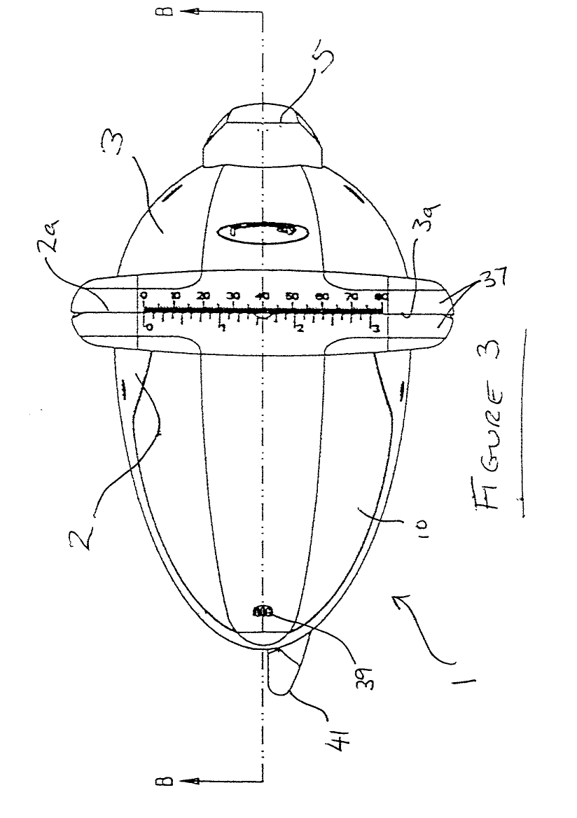

Referring firstly to the vice of FIGS. 1 to 5, the vice 1 is in two sections, a fixed jaw 2 and a moveable jaw 3. The jaws 2,3 are both moulded from plastics material, and both located on an elongate slide 4. The slide 4 comprises a hardened steel bar which can move axially with respect to each of the jaws. In order to guide the jaws with respect to each other, the moveable jaw 3 has guide bars 19 integrally formed therein, one on either side of the slide bar 4, and passing through correspondingly shaped slots 18 in the face of the fixed jaw 2. The guide bars are L-shaped in section. Although any shape would suffice. Hooks 21, formed on the end of the bars 19, catch behind slot 18 and prevent complete separation of the jaws when the moveable jaw is pulled away from the fixed jaw.

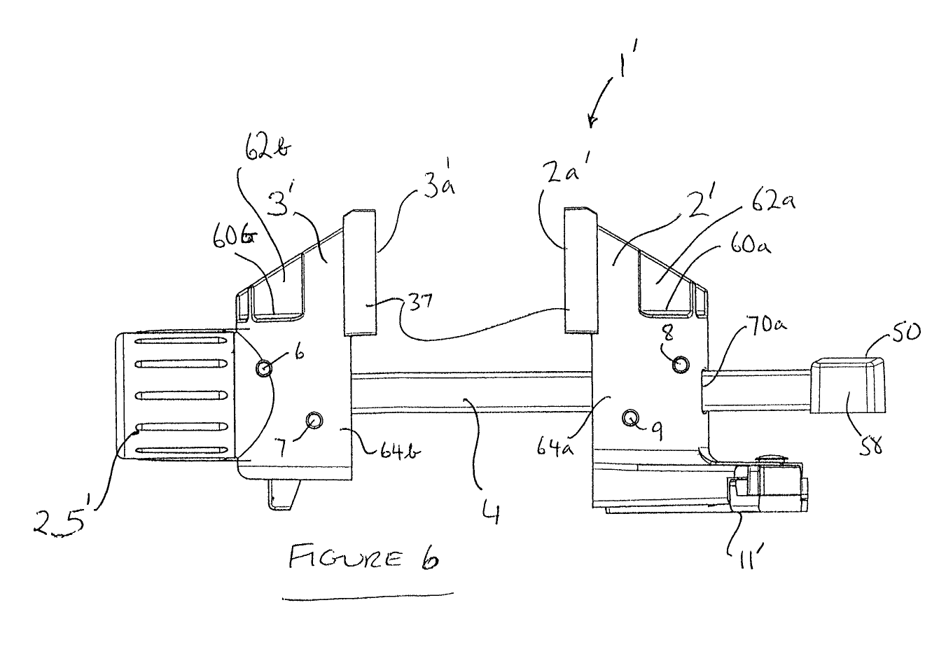

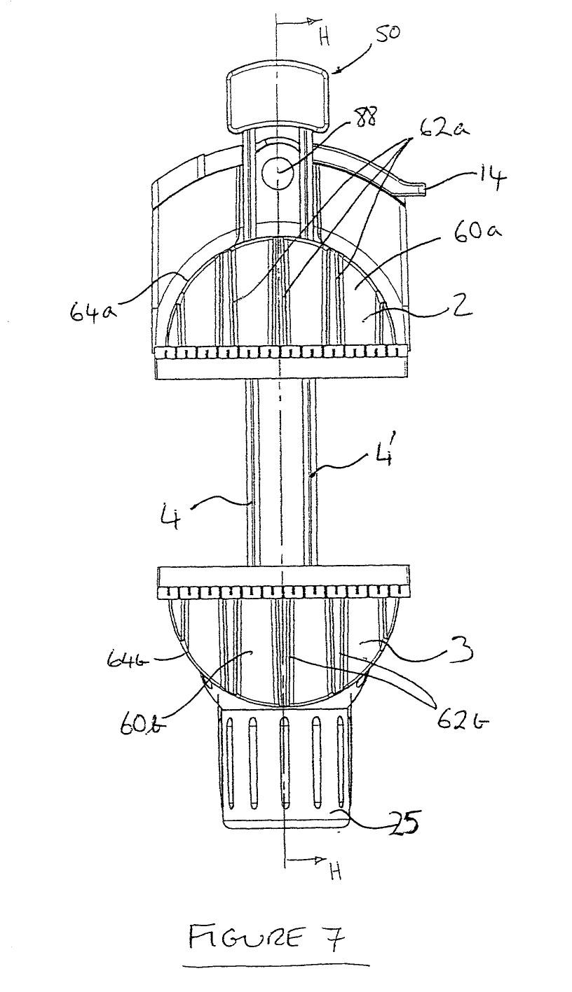

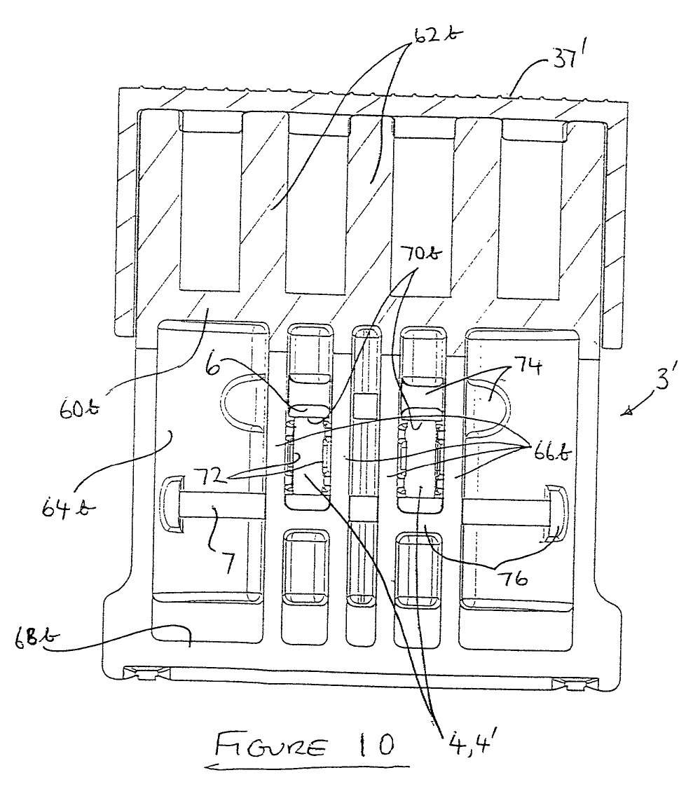

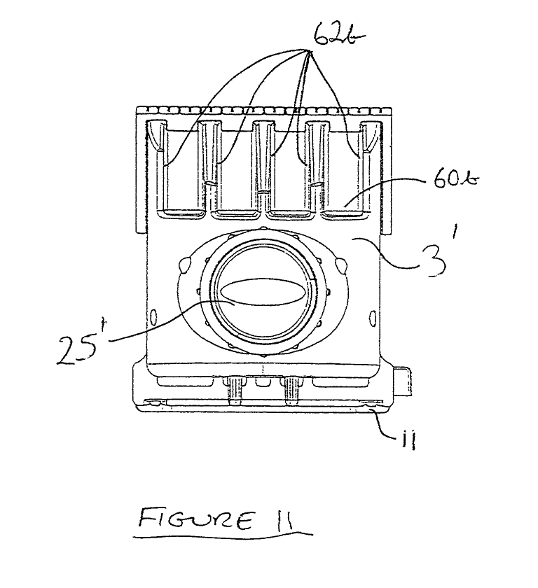

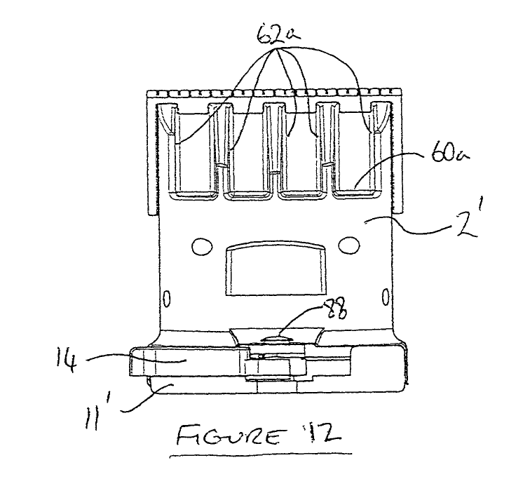

In an alternative arrangement, as shown in the vice of FIGS. 6 to 12, the slide could comprise two or more parallel bars 4,4′, which also serve to reduce lateral twist of one jaw with respect to the other about an axis parallel the slide bar 4.

The end of the slide 4 nearest the movable jaw 3 has a cylindrical, screw-threaded block 5, which is fixed onto the end of the slide 4 by a cross-pin 20 press-fitted in a bore 22 of the block 5 and passing through an eye 24 in the slide 4. Threaded onto the block 5 is a knob 25. When the knob 25 is screwed onto the block 5, rear face 27 of the knob bears against a front face 29 of the moveable jaw 3. This results in a limited movement of the moveable jaw along the slide 4. That movement is limited: firstly, by the knob 25 not being able to push the jaw 3 very far before the base 31 of the knob contacts the block 5; and secondly by catches 33 formed on the block 5. The catches 33 extend rearwardly inside the jaw 3 and serve to hook behind the aperture 35 in the front face 29 of the jaw and through which the slide projects.

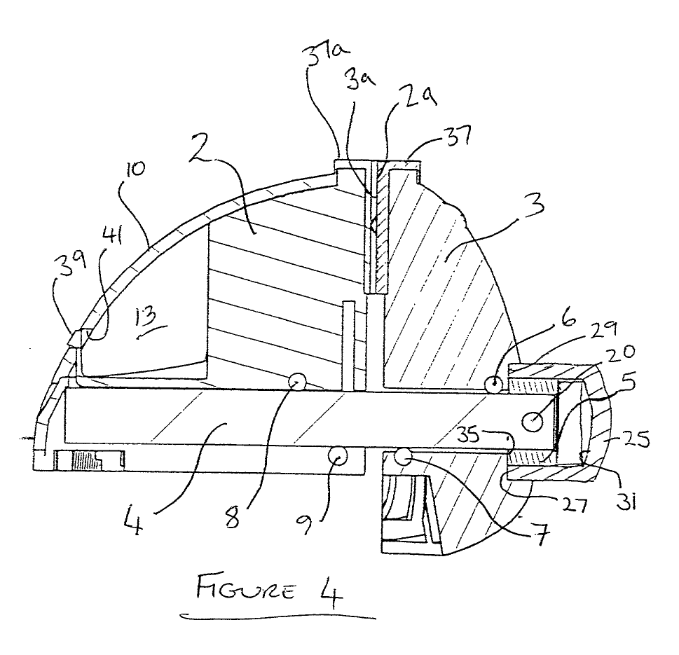

Referring now particularly to FIG. 4, the slide 4 is located within the movable jaw 3 by means of two steel coil roll pins 6,7. The roll pins 6,7 are such that the movable jaw 3 does not grip the slide 4, i.e. the moveable jaw is normally freely slidable on slide 4. This is true even when the vice is “under pressure” i.e. gripping an object in its jaws (as described further below); if it was not so, it would be impossible to undo the vice. In contrast, the fixed jaw 2 is provided with one roll pin 8 (above the slide 4) and a diamond knurled solid pin 9 (below the slide 4). The pins serve to absorb the loads imposed on the plastics body of the vice when an object (not shown) is gripped between the jaws 2,3 and are examples of the “guide means” mentioned in the claims.

Alternative guide means could, for example, comprise moulded plastic guides integral with the jaw. In such an embodiment (not illustrated) pins 6 and 7 in the moveable jaw are replaced with dimensional plastic guides formed as part of the jaw moulding.

The jaws 2,3 are each provided with a jaw face 2a,3a which face one another, are parallel and are transverely disposed with respect to the slide 4, as well as being spaced therefrom. The relatively hard plastics material of the jaws 2,3 may be softened by replaceable pads 37 of elastomeric material.

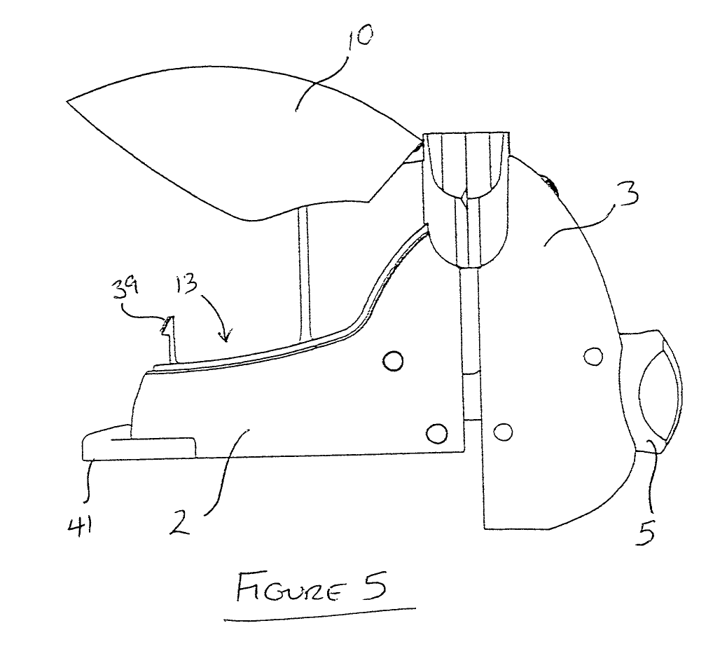

As shown especially in FIGS. 4 and 5, a pocket or compartment 13 is formed in the rear of the fixed jaw 2, which can be used for storage. A hinged lid 10 is formed as a flap on the pad 37a of the fixed jaw 2, an integral hinge 39 permitting the lid 10 to be raised and lowered giving access to the pocket 13. A catch 39 formed on the jaw 2 engages an eye 41 in the lid 10 to retain it closed. The pocket 13 can be used to store useful workshop accessories, for example, pipe clamp pads for rendering the vice more suitable for gripping pipes.

A separable base 11 is provided, by means of which the vice may be fixed to a work surface. In this embodiment, the base comprises a G-clamp comprising a C-shaped body 11a and a screw 12 provided with a handle 12a and pad 12b enabling clamping in the direction of Arrow C against a table edge in a conventional manner. The base is detachable from the main body of the vice 1 so that the vice can be used as a separate clamp or be fitted to a base of a different mode of operation for example, a vacuum base or a G-clamp base. The vice and base have any convenient means of mutual location and secure inter-engagement. All that is shown here is a lever 41 in the fixed jaw 2 which is arranged to be pivotable about an axis 43 and which serves to permit the jaw 2 to move relative to the base 11 so that interlocks (not shown) between the two may be disengaged.

Before operation of the vice 1 is described, a second embodiment of the invention is now described. Referring to FIGS. 6 to 12, equivalent parts are given identical reference numerals to the first embodiment, except with a prime (′) where differences in structure exist. The operating principle of the two embodiments is identical, the differences being primarily of size and strength, as well as aesthetic design features.

In FIGS. 6 to 12, the vice 1′ likewise has a fixed jaw 2′ and a moveable jaw 3′. Likewise a slide 4 joins the two, except this time a second parallel slide 4′ is provided which more rigidly stabilises the angular position of the two jaws with respect to one another. Here, the pins 6 to 9 bear against the edges of both slides 4,4′. On the ends of the bars 4,4′, a stop-block 50 is provided which prevents the jaws from being opened and separated completely. The stop-block 50 is a plastics moulding including an internal, downwardly depending fork catch 52 which snaps onto a cross pin 54 passing through apertures 56 in the two bars 4,4′. Needless to say, the stop block can be snapped off the bars and the pin 54 slid out of the apertures 56 in the bars 4,4′ through which they pass so as to enable such complete separation, if required. Normally, end walls 58 of the stop-block 50 prevent the pin 54 from sliding out.

The vice 1′ of this embodiment is more substantial than the first embodiment and the structural arrangement of each jaw is such as to provide greater strength so that greater gripping power can be achieved, as described further below. Structural rigidity is provided by each jaw 2′,3′ having a front wall 2a′,3a′ (forming front faces of the jaws as described above with reference to the first embodiment and likewise protected by pads 37′). The front walls lie parallel a plane which, in use, is normally vertical. Beneath the front walls 2a′,3a′, the wall extends perpendicularly to provide a bracing surface 60a,b for each jaw 2,3 respectively. Between the bracing surface and front walls of each jaw, first gussets 62a,b are formed which prop-up the front walls and give them strength.

Each jaw 2,3 has a support wall 64a,b depending perpendicularly from the bracing surface 60a,b. Each support wall is semi-cylindrical to further enhance the rigidity of the bracing surface 60a,b. Moreover, second gussets 66a,b extend between the support wall 64a,b and the bracing surface 60a,b. Finally a floor 68a,b extends perpendicularly inwardly, parallel to the bracing surface 60a,b, and again supporting the support wall 64a,b, as well as the second gussets 66a,b.

The support walls 64 define the main body of the vice and through which the slides 4,4′ pass, window pairs 70a,b being formed in each wall 64a,b respectively. Indeed, the second gussets 66a,b are provided with bearing ridges 72 which serve to locate, without substantially increasing sliding friction against, the slide bars 4,4′. Finally, bosses 74,76 are formed through which transverse drillings are subsequently made in which to press fit the pins 6 to 9. The bosses between the second gussets 66a,b also serve to support those gussets, especially near the pins 7,9 which are remote from the support walls 64a,b.

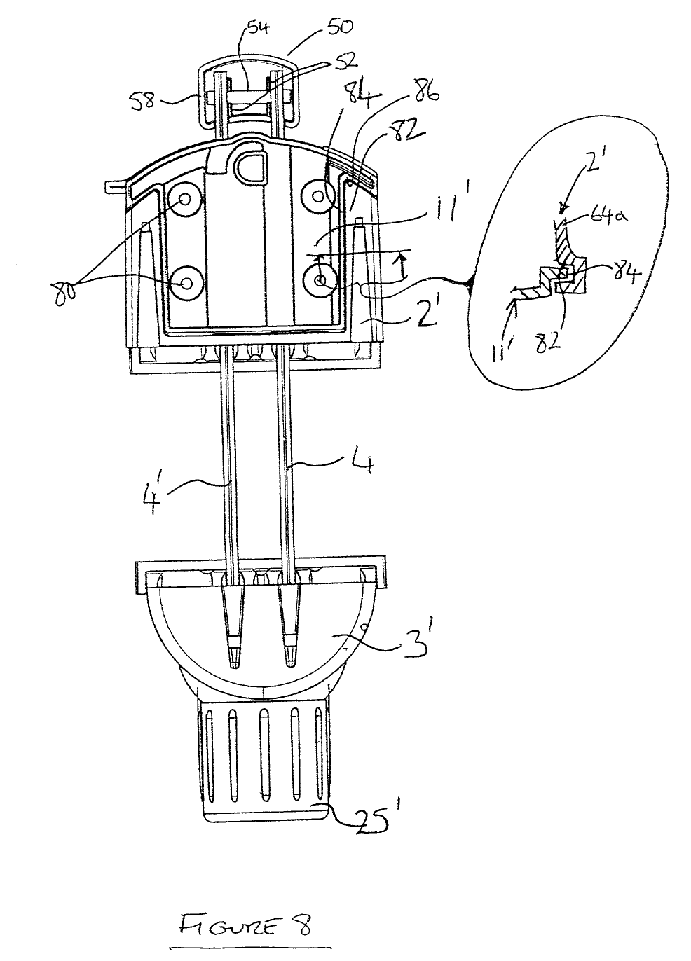

The floor 68b of the moveable jaw 3′ is semicircular in plan, substantially corresponding with the shape in plan of the bracing surface 60b. In fact, the support walls 64 and front walls 2a′,3a′ between them substantially define the extent of the bracing surface in both jaws. However, the floor 68a of the fixed jaw 2′ is more extensive and provides a connection arrangement, not dissimilar to that described above, to a base 11′ which itself is provided with screw holes 80 (see FIG. 8). These are employed to fix the base 11 to a work surface by screws (not shown).

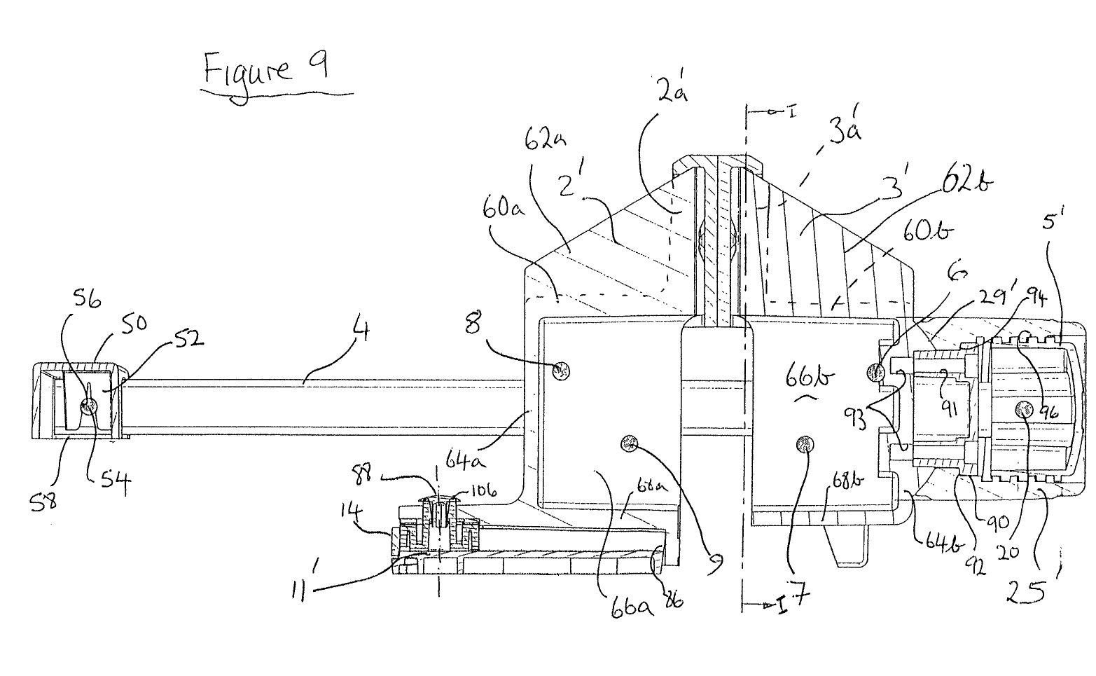

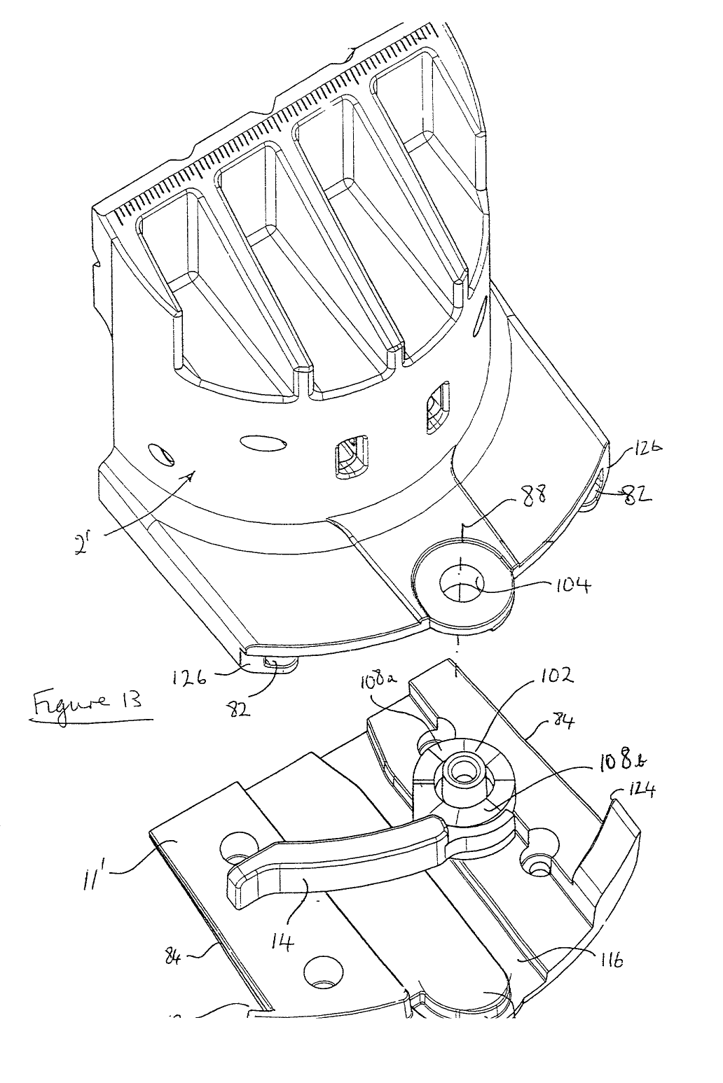

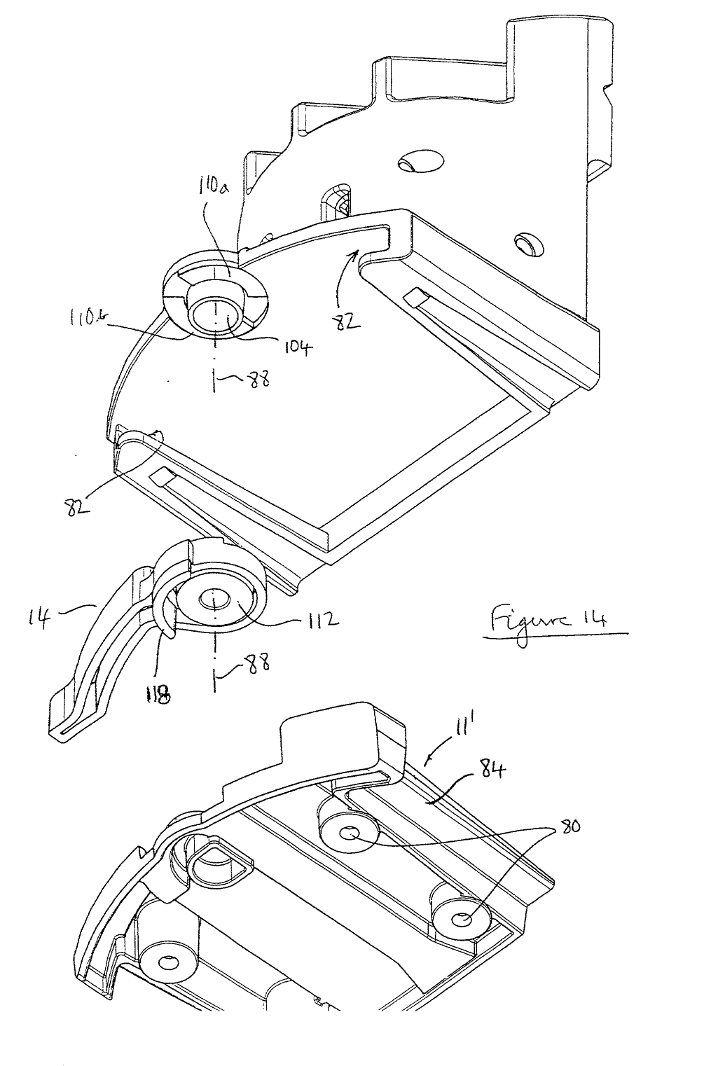

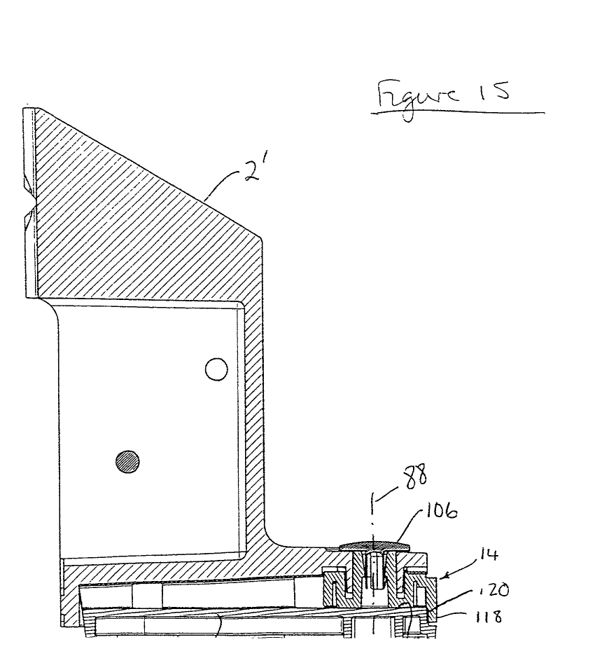

The fixed jaw 2′ is provided with inwardly directed channel sections 82 (see inset to FIG. 8, and FIGS. 13 to 15) along both sides, whose openings face one another. These permit the jaw to be slid along wings 84 upstanding along either side of the base until a stop 86 (FIG. 9) on the jaw engages the base 11′. Then, a cam lever 14, which is pivoted in the jaw 2′ about axis 88, can be rotated from an open position at which it is substantially parallel the slides 4,4′ (and only in which position can the jaw be engaged with the base 11′) to the locked position shown in the drawings.

The cam lever 14 comprises a moulded plastics part having a boss 102 received in a journal 104 in the fixed jaw 2′. A cap 106 holds the cam lever 14 in place. A radially extending ramp 108 is provided around the boss 102, which ramp is in two diametrically opposite parts a,b. Around the journal 104 are corresponding radially extending ramps 110, likewise in two parts a,b. The ramps 108,110 face one another. Consequently, when the cam lever 14 is rotated, the axial separation of the cam lever and jaw 2′ changes. The cam lever 14 has a planar annular base 112 which seats, when the fixed jaw and base are engaged with one another, on a platform 114 formed to one side, and at the end of, a track 116 formed in the base 11′. So, when the cam lever 14 is rotated from its open position to the shown locked position, the fixed jaw 2′ is pressed upwardly against the constraining force of the wings 84 in the channels 82. Therefore, any slack play between the wings 84 and channels 82, in the vertical direction, is accommodated and taken up.

A circumferentially extending part 118 of the cam lever 14 depends downwardly over an arc around the axis 88 of about 70°. When in the open position of the cam lever, the part 118 is aligned with the track 116 in the base 11′ and so the fixed jaw 2′ can be slid along the wings 84. At the end of the track, rotation of the cam lever 14 engages the part 118 with a shoulder 120 which is at least in part spiral with respect to the axis 88. Thus, not only does this movement of the cam lever lock the jaw and base together (because now the part 118 is no longer aligned with the track 116 and therefor prevents withdrawal of the jaw from the base) but also the jaw and base are drawn tightly into engagement with one another to take up any slack play between them in the horizontal plane. Indeed, the curved stops 124 engaging curved ends 126 of the channels 82 further enhance the location of the jaw 2′ on the base 11′.

Turning to FIG. 9, the knob 25′ is assembled on the moveable jaw 3′ by securing it to the face 29′ of the jaw 3′ through an internal clamp plate 90. The clamp plate 90 has screw holes 91 to receive screws (not shown) which fix in corresponding holes 93 in the jaw 3′. The plate 90 also has a circular or part-circular flange 92, which bears against a circular shoulder 94 in the knob 25′ and retains it in a rotationally free but axially fixed position with respect to the jaw 3′. Block 5′ is fixed on the ends of the bars 4′4′ by a pin 20. The bars 4,4′ are then inserted through apertures (not shown) in the plate 90 until thread 96 on the block 5′ engages the corresponding thread in the knob 25′. Rotation of the knob will then engage the two threads and the block will be drawn into the knob to the approximate position shown in FIG. 9.

The operation of the vice is now described, with reference to both embodiments (and ignoring the reference numeral primes (′) unless the context makes clear). In use, with the jaws 2,3 initially open as shown in FIG. 8, for example, the movable jaw 3 is advanced towards the fixed jaw 2 simply by grasping the knob 25. When the jaws 2,3 meet, either each other or an object to be clamped between them, there is a tendency for the top of the fixed jaw 2 to rotate away from the object (or moveable jaw 3) about an axis transverse of the bar 4. This causes the pin pairs 6,7 and 8,9 to squeeze the slide 4, each pair tending to rotate the slide in an opposite sense having the effect of bending the bar about the same transverse axis. That is why the section of the slide is elongate in a vertical plane to resist such bending. Because the pin 9 is knurled, it grips the slide 4 and this provides a jamming action. There is no gripping between the pins 6,7 and so further pressure can be applied by rotating the knob 25 to press the moveable jaw against the fixed jaw. Indeed, the tightness with which the jaws can be pressed together is only limited by the material and strength of the vice. Consequently, because the vice is constructed from plastics material, neither knob 25,25′ is provided with a lever. Moreover, knob 25 of the first embodiment has relatively small dimensions so as to limit the leverage possible compared with the more substantial knob 25′ of the second embodiment. Indeed, the second embodiment can be constructed to provide clamping forces of about 2.5 KN in a normal-sized vice (ie with an approximately 100 mm jaw size).

To release the vice pressure, the screw-threaded knob 25 is simply undone, loosening the movable jaw 3 and allowing the object to be retrieved. Release of pressure on the fixed jaw 2 allows the fixed jaw (and hence the knurled pin 9) to rotate back into the start position. Whereupon complete opening of the vice can be effected by simple sliding of the jaws with respect to one another.

Indeed, it is an important feature of the present invention that it can be operated entirely with one hand, from coarse adjustment to final tightening without release of the knob 25. This enables an object held in the user's other hand to be positioned accurately in the vice during that process.

The block 5 and knob 25 are ideally screw-threaded to one another, as shown in the drawings and described above. This provides the most convenient form of mechanism for final advancement of the moveable jaw, and indeed provides the most convenient handle for both such final movement and general sliding of the jaws with respect to one another. Nevertheless, any other form of cam or lever arrangement could be employed if desired.

A particular aspect of the second embodiment is the structural rigidity provided by the convoluted wall 2a′,3a′/60a,b/64a,b/68a,b and the supporting gussets 62a,b/66a,b. This arrangement enables a strong vice to be made which is capable of relatively high clamping pressures —despite being constructed from plastics material, and despite still being of relatively simple form capable of moulding of each jaw in two-part moulds.

A particular aspect of the first embodiment is the provision of a useful pocket for storage of accessories or the like.

1. A bench vice comprising:
a fixed jaw having a first face;
a moveable jaw having a second face adapted to face the first face;
a bar connecting the jaws, along which bar the jaws are slidable towards and away from one another, the bar being arranged transversely of said faces and being laterally spaced therefrom;
a guide means in the fixed jaw forming a jamming mechanism to selectively prevent sliding of the fixed jaw with respect to the bar; and,
cam knob on the bar acting on the moveable jaw and adapted, on actuation by a user, to urge the moveable jaw along the bar towards the fixed jaw.

2. A bench vice as claimed in claim 1, in which the fixed and movable jaw are made substantially of plastics material.

3. A bench vice as claimed in claim 1, in which guide means are also provided in the movable jaw and in which both guide means resist rotational movement of the fixed jaw or, as the case may be, the movable jaw, about a transverse axis through the bar caused by direct or indirect contact between the first and second faces.

4. A bench vice as claimed in claim 3, wherein the guide means in the movable jaw comprises moulded plastics guides, integral with the jaw.

5. A bench vice as claimed in claim 1, further comprising a cam knob on the bar acting on the moveable jaw and adapted, on actuation by a user, to urge the moveable jaw along the bar towards the fixed jaw.

6. A bench vice as claimed in claim 5, in which the cam knob is so arranged that a user can grasp the knob with one hand and use the knob both as a handle with which to slide the movable jaw back and forth along the bar with respect to the fixed jaw, so that an object can be adjustably positioned between the jaw faces and, on actuation of the knob, to clamp finally the object between the faces.

7. A bench vice as claimed in claim 6, in which the cam knob is screw threaded on a stud member formed on the end of the bar and has an end bearing surface which is adapted to engage a front surface of the moveable vice jaw.

8. A bench vice as claimed in claim 1, in which said jamming mechanism comprises pins disposed in the fixed jaw above and below the bar and arranged to bear against the bar and resist rotational movement of the fixed jaw about a transverse axis through the bar caused by direct or indirect contact between the first and second faces, the pins being able to jam against the bar and prevent its sliding in the fixed jaw when pressure on the first face tends to create said rotational movement.

9. A bench vice as claimed in claim 8, in which said pins are offset with respect to one another in the direction of said bar, the pin in each jaw nearest the bar being disposed on the same side of the bar as the jaw faces.

10. A bench vice as claimed in claim 8, wherein at least one pin is knurled so as to jam against the bar.

11. A bench vice as claimed in claim 1, in which the bar is an elongate rectangle in section.

12. A bench vice as claimed in claim 8, in which said bar is elongated in section in the direction of a line joining said pins.

13. A bench vice as claimed in claim 1, in which the fixed jaw comprises a base selectively detachable from the fixed jaw and which includes means for secure fixation to a bench or like surface.

14. A bench vice as claimed in claim 13, in which the fixation means comprises a screw clamp having a screw adapted to clamp on an edge of a bench.

15. A bench vice as claimed in claim 13, in which the fixation means comprises screw holes to receive screws with which to fix the base to the bench or like surface.

16. A bench vice as claimed in claim 13, in which one of the base or fixed jaw has opposing wings adapted to slide in facing channels formed in the other of the base or fixed jaw, whereby the fixed jaw can slide into engagement with the base, retention means being provided to selectively prevent disengagement of one from the other.

17. A bench vice as claimed in claim 16, in which the retention means also wedges the fixed jaw and base together so that there is no slack play between them.

18. A bench vice as claimed in claim 16, in which said retention means comprises a cam lever pivotally disposed in one of the base and fixed jaw and is provided with a cam surface which, on pivoting of said cam lever, both locks the base to the fixed jaw and wedges between them.

19. A bench vice as claimed in claim 18, in which said cam surface is in two parts, a first circumferential part forming a spiral centred on the axis of said pivot, and a second radial ramp surrounding said pivot, each part adapted to press corresponding surfaces of the fixed jaw and/or base on actuation of the lever to press the fixed jaw and base with respect to one another in orthogonal directions.

20. A bench vice as claimed in claim 18, in which the cam lever is pivoted on the bottom of the fixed jaw, and a track is formed in the base in which said circumferential part slides when said cam lever is in an open position and the fixed jaw is slid into engagement with the base, the circumferential part engaging a first of said corresponding surfaces, which first surface is of the base to one side of the end of the track when the fixed jaw is fully engaged with the base and the cam lever is rotated to a locked position thereof.

21. A bench vice as claimed in claim 19, in which the cam lever is pivoted on the bottom of the fixed jaw, and said radial ramp engages a second of said corresponding surfaces, which second surface is formed in the fixed base and comprises a radially disposed ramp surrounding the pivot of the cam lever.

22. A bench vice comprising:
a fixed jaw comprising an injection moulding of plastics material and having a first face;
a moveable jaw, also comprising an injection moulding of plastics material and having a second face adapted to face the first face;
a bar connecting the jaws, along which bar the jaws are slidable towards and away from one another, the bar being arranged transversely of said faces and being laterally spaced therefrom; and,
guide means disposed in each jaw above and below the bar and arranged to bear against the bar and resist rotational movement of the jaws about transverse axes through the bar caused by direct or indirect contact between the first and second faces, the guide means on the fixed jaw forming a jamming mechanism to selectively prevent the bar from sliding in the fixed jaw when pressure on the first face tends to create said rotational movement; wherein,
the fixed jaw comprises a wall extending both from the top to bottom of the fixed jaw and from side to side of the fixed jaw; the wall forming:
said first face in a first plane at the top of the fixed jaw;
a bracing surface substantially perpendicular to said first plane intermediate said top and bottom of the jaw, first gussets extending between said first face and bracing surface in order to support the first face;
a substantially cylindrical support wall, having an axis extending transversely to said bracing surface, between them the support wall and first face substantially defining the extent of said bracing wall; and,
a floor forming a base of the fixed jaw arranged substantially perpendicular to said first plane and having second gussets extending between said floor, support wall and bracing wall.

23. A bench vice as claimed in claim 22, further comprising a cam knob on the bar acting on the moveable jaw and adapted, on actuation by a user, to urge the moveable jaw along the bar towards the fixed jaw.

24. A bench vice as claimed in claim 22, wherein the guide means in the movable jaw comprises moulded plastics guides, integral with the jaw.

25. A bench vice as claimed in claim 22, in which said jamming mechanism comprises pins disposed in the fixed jaw above and below the bar and arranged to bear against the bar and resist rotational movement of the fixed jaw about a transverse axis through the bar caused by direct or indirect contact between the first and second faces, the pins being able to jam against the bar and prevent its sliding in the fixed jaw when pressure on the first face tends to create said rotational movement.

26. A bench vice as claimed in claim 25, in which said pins are offset with respect to one another in the direction of said bar, the pin in each jaw nearest the bar being disposed on the same side of the bar as the jaw faces.

27. A bench vice as claimed in claim 25, in which said pins in the fixed jaw extend through at least two of said second gussets, at least one on either side of the bar.

28. A bench vice as claimed in claim 25, wherein at least one pin is knurled so as to jam against the bar.

29. A bench vice as claimed in claim 25, in which said bar is elongated in section in the direction of a line joining said pins.

30. A bench vice as claimed in claim 22, in which the fixed jaw comprises a base selectively detachable from the fixed jaw and which includes means for secure fixation to a bench or like surface.

31. A bench vice as claimed in claim 30, in which one of the base or fixed jaw has opposing wings adapted to slide in facing channels formed in the other of the base or fixed jaw, whereby the fixed jaw can slide into engagement with the base, retention means being provided to selectively prevent disengagement of one from the other.

32. A bench vice as claimed in claim 31, in which the retention means also wedges the fixed jaw and base together so that there is no slack play between them.

33. A bench vice comprising:
a fixed jaw comprising an injection moulding of plastics material and having a first face;
a moveable jaw, also comprising an injection moulding of plastics material and having a second face adapted to face the first face;
a bar connecting the jaws, along which bar the jaws are slidable towards and away from one another, the bar being arranged transversely of said faces and being laterally spaced therefrom; and,
guide means disposed in each jaw above and below the bar and arranged to bear against the bar and resist rotational movement of the jaws about transverse axes through the bar caused by direct or indirect contact between the first and second faces, the guide means on the fixed jaw forming a jamming mechanism to selectively prevent the bar from sliding in the fixed jaw prevent its sliding in the fixed jaw when pressure on the first face tends to create said rotational movement; wherein, the fixed jaw comprises a pocket forming a store, which pocket is on the jaw on a side of said first face remote from the second face.

34. A bench vice as claimed in claim 33, in which the faces are formed from discrete elastomeric material inserts attached to the jaws's, and in which the insert on the face of the fixed jaw has a hinged extension forming a cover for said pocket.

35. A bench vice as claimed in claim 33, further comprising a cam knob on the bar acting on the moveable jaw and adapted, on actuation by a user, to urge the moveable jaw along the bar towards the fixed jaw.

36. A bench vice as claimed in claim 33, wherein the guide means in the movable jaw comprises moulded plastics guides, integral with the jaw.

37. A bench vice as claimed in claim 33, in which said jamming mechanism comprises pins disposed in the fixed jaw above and below the bar and arranged to bear against the bar and resist rotational movement of the fixed jaw about a transverse axis through the bar caused by direct or indirect contact between the first and second faces, the pins being able to jam against the bar and prevent its sliding in the fixed jaw when pressure on the first face tends to create said rotational movement.

38. A bench vice as claimed in claim 37, in which said bars are elongated in section in the direction of a line joining said pins.

39. A bench vice as claimed in claim 33, in which the fixed jaw comprises a base selectively detachable from the fixed jaw and which includes means for secure fixation to a bench or like surface.

40. A bench vice comprising:
a fixed jaw comprising an injection moulding of plastics material and having a first face;
a moveable jaw, also comprising an injection moulding of plastics material and having a second face adapted to face the first face;
a bar connecting the jaws, along which bar the jaws are slidable towards and away from one another, the bar being arranged transversely of said faces and being laterally spaced therefrom; and
guide means disposed in each jaw above and below the bar and arranged to bear against the bar and resist rotational movement of the jaws about transverse axes through the bar caused by direct or indirect contact between the first and second faces, the guide means on the fixed jaw forming a jamming mechanism to selectively prevent the bar from sliding in the fixed jaw when pressure on the first face tends to create said rotational movement; wherein,
no more than one bar is provided, a stabilising rod being integrally formed on the movable jaw parallel the bar and extending through a slot in the fixed jaw to stabilise the movable jaw and reduce any tendency of the movable jaw to rotate relative to the fixed jaw about an axis along the bar.

41. A bench vice as claimed in claim 40, in which the rod is L-shaped in section.

42. A bench vice as claimed in claim 41, in which two stabilising rods are provided, one on either side of the bar.

43. A bench vice as claimed in claim 40, further comprising a cam knob on the bar acting on the moveable jaw and adapted, on actuation by a user, to urge the moveable jaw along the bar towards the fixed jaw.

44. A bench vice as claimed in claim 40, wherein the guide means in the movable jaw comprises moulded plastics guides, integral with the jaw.

45. A bench vice as claimed in claim 40, in which said jamming mechanism comprises pins disposed in the fixed jaw above and below the bar and arranged to bear against the bar and resist rotational movement of the fixed jaw about a transverse axis through the bar caused by direct or indirect contact between the first and second faces, the pins being able to jam against the bar and prevent its sliding in the fixed jaw when pressure on the first face tends to create said rotational movement.
